(19) United States
(12) Patent Application Publication
(10) Pub. No.: US 2003/0156935 A1
(43) Pub. Date: Aug. 21, 2003

(54) Fork movement assembly for lift trucks

(76) Inventors: Luciano Mondani, Piacenza (IT); Mark Dodd, Seneca, SC (US)

Correspondence Address: Michelle N. Lester, Esq.,, NIXON & VANDERHYE P.C.,, 1100 North Glebe Rd., 8th Floor,, Arlington, VA, 22201-4714, US

(21) Appl. No.: 10/078,521

(22) Filed: Feb. 21, 2002

(51) Int. Cl. B66F 9/14

(52) U.S. Cl. 414/667

(57) ABSTRACT

A side shifting and fork positioning assembly for a lift truck is disclosed. The assembly includes a carriage which moves in a lift truck mast. The carriage includes a pair of horizontally spaced apart vertical members and a frame support member secured transversely to the vertical members. A side shift frame slides on the carriage. An upper cross member of the side shift frame supports two forks along their hook portion. Hydraulically actuated cylinders located in the frame support member move the side shift frame. The assembly also includes first and second fork shoes movably secured to the side shift frame. Each of the fork shoes define a contact surface to engage the forks. The contact surface of the fork shoes is located no further forward than a front face of the upper cross member. The assembly includes a fork positioner which moves the first fork shoe relative to the second fork shoe, where the fork shoes are maintained at an equal distance from the center of the side shift frame.

### FIELD OF THE INVENTION

The invention is related to lift trucks, and in particular, to assemblies for moving lift truck forks.

### BACKGROUND OF THE INVENTION

Lift trucks are vehicles which are used to pick up and move loads from place to place. A conventional lift truck includes a carriage which supports a pair of forks. The forks are maneuvered into place by the lift truck operator and are used to pick up the load. The carriage rides vertically in a mast, which also supports the carriage.

Several attachments to enhance the capabilities of the lift truck are known in the art. One such attachment is a side shift assembly which facilitates aligning the spaced pair of forks with the load. The term “side shifting” is used to describe the concept of shifting the forks as a spaced pair either left or right of the vehicle center line. This function provides the operator with a greater margin for error when aligning the vehicle with the load. If the operator positions the vehicle incorrectly, the error can be corrected by maneuvering the pair of forks either left or right with the side shifting assembly. Side shifting attachments typically use hydraulics to move the pair of forks.

There are several types of conventional side shifting assemblies. One such type hangs on to the typical carriage bar of a conventional lift truck carriage. Such a “hang-on” side shifting assembly is disclosed in U.S. Pat. No. 5,807,060. Because this type of side shifting assembly is positioned forward of the carriage, it undesirably increases the load moment (also referred to as “lost load”) by moving the load center further forward of the lift truck. In addition, the hydraulic cylinder and hoses are located close to the carriage where they obstruct the operator's view.

Another conventional side shifting assembly is built within the carriage bar and is referred to as an integral side shifting assembly. The assembly utilizes hydraulic pistons to shift a frame which in turn supports the forks. The conventional integral side shifting assemblies disadvantageously expose the moving parts of the assembly to possible damage from the forks.

Another known attachment to enhance the capability of a lift truck is a fork positioning assembly. The term fork positioning is used to describe the concept of changing the relative spacing between the forks to accommodate loads of different widths and pick up requirements. A fork positioning attachment provides additional flexibility for the operator by allowing the operator to pick up different size pallets. One such fork positioning assembly is disclosed in German Patent No. DE 198 05 790. The disclosed assembly hangs on a conventional carriage bar or a side shifting frame, thereby again increasing the lost load.

Increasing the lost load has a number of important disadvantages. It results in a decreased load capacity of a lift truck. Alternatively, it requires an increased counterweight or moving the counterweight rearwards. Both options make the lift truck more expensive to manufacture and the latter option decreases the turning radius of the truck. A less maneuverable lift truck creates a significant disadvantage for the owners and operators of storage facilities by requiring wider aisles and decreasing the space available for storage.

Accordingly, there is a need for a side shifting assembly where the moving parts are protected. There is also a need for a side shifting and fork positioning assembly which reduces lost load.

### SUMMARY OF THE INVENTION

According to a first aspect of the invention, a fork movement assembly for a lift truck is provided. The fork movement assembly comprises:

a carriage, said carriage comprising a pair of horizontally spaced apart vertical members adapted to be movably secured within the lift truck mast, and a frame support member secured transversely to said vertical members;

a side shift frame, said side shift frame comprising an upper cross member slidably connected to said frame support member, a spaced apart lower cross member, and two side members connecting said upper cross member to said lower cross member, said upper cross member being adapted to support forks at hook portions of the forks, said upper cross member defining a front face, said lower cross member defining a sliding surface, said sliding surface being adapted to permit fork positioning wherein the shank portion of the fork is located no further forward than said front face of said upper cross member; and

a side shift operator means for causing movement of said side shift frame along said frame support member, said side shift operator means being located within a portion of said frame support member.

According to a second aspect of the invention, a side shift assembly for a lift truck having a mast and a pair of forks is provided. The side shift assembly comprises:

(a) a carriage, said carriage comprising a pair of horizontally spaced apart vertical members adapted to be movably secured within said mast, and a frame support member secured transversely to said vertical members; said frame support member defining an upper contact surface;

(b) a side shift frame, said side shift frame comprising an upper cross member adapted to support said forks, said upper cross member defining:

(i) a planar front portion covering a front face of said frame support member, and

(ii) a lower contact surface adapted to engage said upper contact surface of said frame support member for sliding movement thereon; and

(c) a side shift operator means for movement of said side shift frame along said frame support member, said shift means being located in a portion of said frame support member.

According to a third aspect of the invention, a fork movement assembly for a lift truck having is provided. The fork movement assembly comprises:

a carriage having a pair of horizontally spaced apart vertical members adapted to be movably secured within the lift truck mast, and a frame support member secured transversely to said vertical members;

a side shift frame having an upper cross member slidably connected to said frame support member, said upper cross member being adapted to support forks along their hook portion;

a shift means for movement of said side shift frame along said frame support member, said shift means being located in a portion of said frame support member;

a first fork shoe and a second fork shoe movably secured to said side shift frame, each of said fork shoes defining a fork contact surface adapted to engage said shank portion, said fork contact surface being located no further forward than a front face of said upper cross member; and

a fork positioning means for moving said first fork shoe relative to said second fork shoe, wherein said first and second fork shoes are maintained at an equal distance from the center of said side shift frame, said fork positioning means being operatively connected to said fork shoes.

### BRIEF DESCRIPTION OF THE DRAWINGS

The invention will now be described, by way of example only, with reference to the accompanying figures, where:

FIG. 1 is a front perspective view of a preferred embodiment of the fork movement assembly in accordance with the present invention;

FIG. 2 is a perspective view of the carriage portion of the fork movement assembly shown in FIG. 1;

FIG. 3 is a rear perspective view of the preferred embodiment;

FIG. 4 is a front plan view of the preferred embodiment;

FIG. 5 is a cross-sectional view of the frame support member of the preferred embodiment;

FIG. 6 is an elevation view of the preferred embodiment;

FIG. 7 is a cross-sectional view of the preferred embodiment along line A-A in FIG. 4; and

FIG. 8 is a cross-sectional view of the preferred embodiment along line B-B in FIG. 4.

### DETAILED DESCRIPTION OF THE INVENTION

For the purposes of this specification, “front” or “forward” refers to the load carrying face of the truck to which the forks are attached, and “rear” refers to the opposite end of the lift truck where the counterweight is typically located. “Side” or “sideways” refers to the left and right sides of the lift truck, as the case may be.

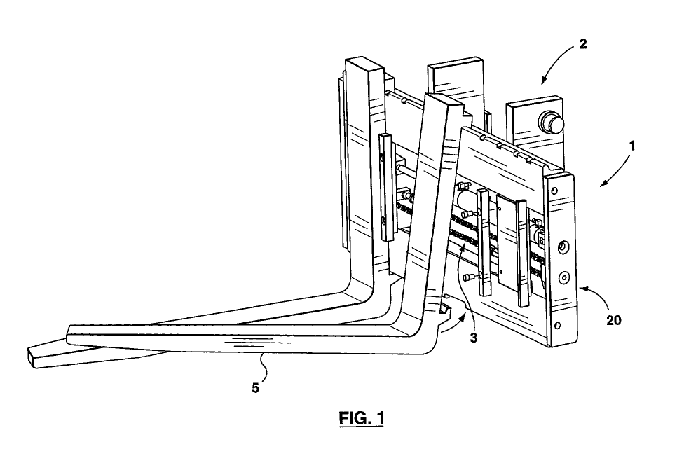

FIG. 1 shows a fork movement assembly 1 for moving a pair of forks 5. The fork movement assembly 1 includes a carriage 2, a side shift frame 20, and fork positioner 3.

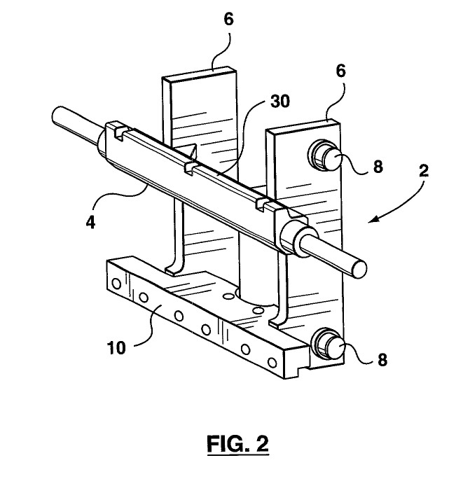

FIG. 2 shows the carriage 2 which includes a frame support member 4 secured to two spaced apart vertical members 6 in any suitable manner, such as by welding. Each vertical member 6 includes two or more bearings 8 to permit the carriage 2 to move vertically along a lift truck mast (not shown). The vertical members 6 are also welded to a lower carriage bar 10.

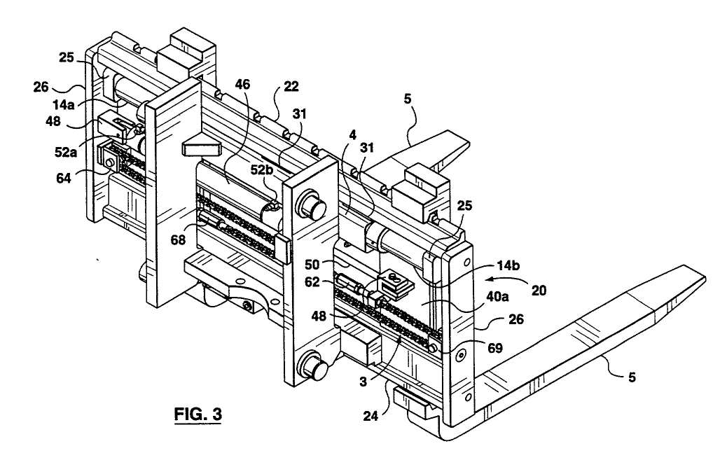

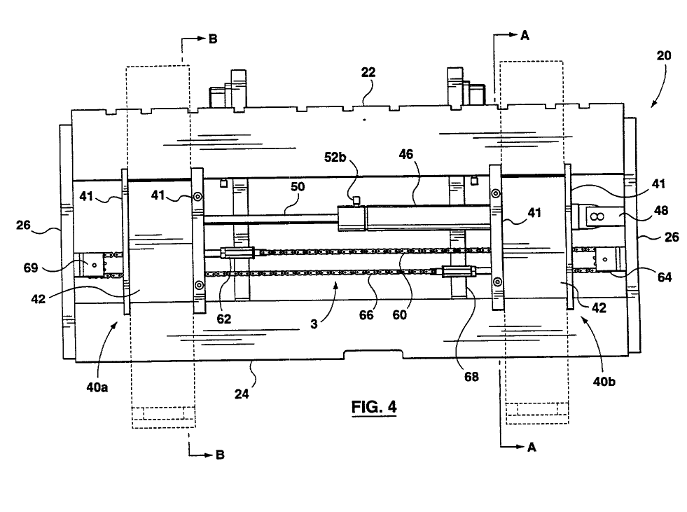

Referring to FIGS. 3 and 4, the frame support member 4 supports the side shift frame 20 which is configured to slide sideways along the frame support member 4 (described in detail below). The side shift frame 20 includes a horizontal upper cross member 22 and lower cross member 24 joined together by side members 26 to form a preferably rectangular shape. The side shift frame 20 can be joined in any suitable manner, but is preferably welded together. The upper cross member 22 supports the forks 5 by having a hook located on the shank portion of the fork 5 engage the upper cross member 22. Two contact pads 25 are secured to upper cross member 22.

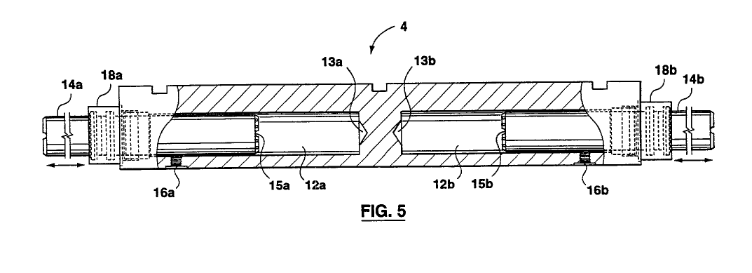

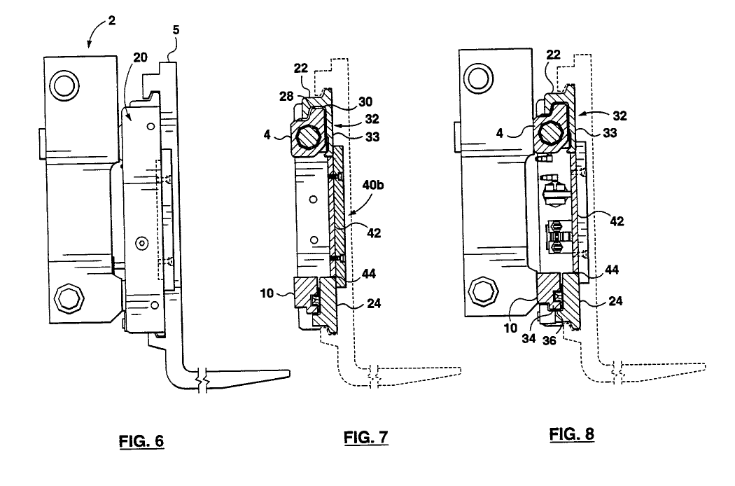

Referring to FIGS. 3 and 5, the side shift frame 20 is moved along the frame support member 4 by a side shift operator means. Preferably, the side shift operator means is provided by pistons 14a and 14b which abut against corresponding contact pads 25. The contact pads 25 permit a standard carriage 2 of a fixed width to accommodate side shift frames 20 of differing widths. As best shown in FIG. 5, the pistons 14a, 14b are received within axial cavities 12a and 12b, respectively, defined in the frame support member 4. The cavities 12a, 12b are preferably machined into the frame support member 4, and preferably include chamfered holes 13a and 13b machined into the interior end of each cavity. The cavities 12a, 12b communicate with hydraulic fluid ports 16a and 16b, respectively. A seal between the pistons 14a, 14b and the cavities 12a, 12b is provided by gland nuts 18a and 18b. The pistons 14a, 14b each have a notch 15a, 15b machined along a diameter of their interior end. It will be understood by those skilled in the art that other suitable shift means, such as electrical motors or chain drives may be employed

Referring to FIGS. 2 and 7, the upper cross member 22 includes a lower contact surface 28 which engages an upper contact surface 30 of the frame support member 4 to facilitate sliding movement of the side shift frame 20 along the frame support member 4. Preferably, the engagement is achieved by providing a concave cross-sectional shape to the lower contact surface 28 and a convex cross-sectional shape to the upper contact surface 30. These shapes ensure that the position of the upper cross member 22 above the frame support member 4 is maintained. However, it will be understood by those skilled in the art that the shapes may be reversed, or other configurations suitable for sliding engagement may be provided. As best shown in FIG. 3, wear pads 31 are secured to the convex contact surface 30 to protect the frame support member 4 and upper cross member 22 against wear and tear. The upper cross member 22 also includes a planar portion 32 which overhangs the frame support member 4 in order to protect the moving parts, such as the pistons 14a, 14b from being damaged by the load or the forks 5. The planar portion 32 of the upper cross member 22 has a front face 33. The shapes of the contact surfaces 28, 30 of the upper cross member 22 and frame support member 4, respectively, as well as the shape of the planar portion 32 all contribute to minimizing the lost load caused by the addition of the side shift frame 20.

Referring to FIG. 8, the lower carriage bar 10 includes a rail portion 34 which engages a track 36 defined in the lower cross member 24. Again, wear pads 31 are provided to protect the lower carriage bar 10 and lower cross member 24.

FIG. 4 shows first and second fork shoes 40a and 40b. Each fork shoe includes preferably two ribs 41, which engage the shank portion of the fork for the positioning thereof, although any other suitable means for engaging the fork may be used. Each fork shoe defines a fork contact surface 42 between the ribs 41, against which the rear of the shank portion of the fork rests.

Referring now to FIG. 7, the fork shoes 40a, 40b preferably ride along a sliding surface 44 defined in an upper portion of lower cross member 24. The fork contact surface 42 of each fork shoe 40a, 40b is located no further forward than the plane defined by the front face 33 of upper cross member 22. More preferably, the front face of the entire side shift frame 20 (against which the rear of the forks rest) and the contact surfaces 42 of fork shoes 40a, 40b are coplanar with front face 33. Accordingly, the addition of the fork positioning shoes 40a, 40b does not increase the load moment on the lift truck.

Referring to FIGS. 3 and 4, the fork positioner 3 comprises a combination of a hydraulic assembly and a chain drive, as described below. One end of a hydraulic cylinder 46 is mounted to a side member 26 adjacent to the second fork shoe 40b. Preferably, the hydraulic cylinder 46 is mounted to the side member 26 by being bolted to a cylinder clevis 48, which in turn is bolted to side member 26. A movable cylinder rod 50 is received and sealed within the hydraulic cylinder 46 in a conventional manner. A free end of the cylinder rod 50 is mounted to the rear of the first fork shoe 40a in any suitable fashion, such as a cylinder clevis and bolt arrangement similar to that described above. Two hydraulic fluid ports, 52a and 52b are located at each end of the cylinder.

It will be understood by those skilled in the art that any other suitable means for moving the first fork shoe 40a may be provided. For example, the fork positioning means may be an electric motor and gear drive system.

Referring again to FIGS. 3 and 4, the fork positioner 3 includes a centering assembly to move the second fork shoe 40b upon movement of the first fork shoe 40a, in order to maintain the fork shoes at an equal distance from the center of the side shift frame 20. The centering assembly includes an upper chain 60, which is preferably secured to the rear of the first fork shoe 40a by first chain mount 62, and to side member 26 adjacent to fork shoe 40b by chain sprocket 64. The upper chain 60 is also secured to fork shoe 40b by second chain mount 68. A lower chain 66 is preferably secured to the rear of the second fork shoe 40b by second chain mount 68, and to side member 26 adjacent to fork shoe 40a by chain sprocket 69. The lower chain 66 is secured to fork shoe 40a by first chain mount 62. Chain mounts 62, 68 each receive chain connections at their ends to form a continuous chain loop. The sprockets 64, 69 are preferably made from a sintered steel for improved wear characteristics. It will be understood by those skilled in the art that the centering of the fork shoe 40a, 40b may be coordinated by other suitable means, such as cables or a gear drive.

It will be understood by those skilled in the art that the fork movement assembly 1 may also be provided without the fork shoes 40 and the fork positioner 3. This provides the advantage of greater flexibility for the operator, who may want only the side shifting function or would prefer to buy components in stages to defer the additional cost of a fork positioning function. An additional advantage of the present invention, is that the fork shoes 40 and fork positioner 3 can easily be retrofitted in the field, should the user want to add the fork positioning function at a later date. This advantage avoids the need of sending the assembly back to a specialized service facility or having to replace the existing assembly with a new assembly having both side shifting and fork positioning capability.

Referring again to FIGS. 3 and 5, the side shifting operation of the fork movement assembly will now be described. In order to side shift the pair of forks to one side, the operator pumps hydraulic fluid from a source (not shown) into cavity 12a through port 16a. The force of the fluid will push the piston 14a out of cavity 12a. The piston 14a forces the side shift frame 20 to move in the same direction by pushing against contact pad 25 secured to upper cross member 22. At the same time, piston 14b will be moved into cavity 12b, causing the fluid to leave cavity 12b through port 16b. If the operator moves the side shift frame 20 to the very end of its range of movement, the impact of the piston 14b against of wall of cavity 12b is cushioned by forcing the hydraulic fluid remaining in hole 13b to escape through the restricted notch 15b in the end of the piston 14b.

In order to move the side shift frame 20 in the opposite direction, the operator pumps hydraulic fluid into cavity 12b, which causes the side shift frame 20 to move in the opposite direction, in a fashion similar to that described above.

Referring to FIGS. 3 and 4, the fork positioning operation of the fork movement assembly 1 will now be described. In order to decrease the distance between the forks 5, the operator pumps hydraulic fluid into port 52b. The hydraulic fluid forces the rod 50 to be retracted into the hydraulic cylinder 46, which in turn causes the first fork shoe 40a to be moved toward the opposite side of the side shift frame 20. As the first fork shoe 40a moves, it pulls on the chain loop formed by the upper chain 60 and the lower chain 66. As the second fork shoe 40b is secured to lower chain 66, it simultaneously moves toward its opposite side of the side shift frame 20. Consequently, the fork shoes 40a, 40b move toward each other equidistantly. This provides the important advantage of continued centering of the forks on the side shift frame 20, thereby reducing the likelihood of eccentric loads.

In order to increase the distance between the forks 5, the operator pumps hydraulic fluid into port 52a, causing the rod 50 to be pushed out of the hydraulic cylinder 46. The fork shoes 40a, 40b are then moved apart in the same manner as described above.

The present invention may be embodied in other specific forms without departing from the spirit or essential characteristics thereof. The presently disclosed embodiments are therefore to be considered in all respects as illustrative and not restrictive, the scope of the invention being indicated by the appended claims rather than the foregoing description, and all changes which come within the meaning and range of equivalency of the claims are therefore intended to be embraced therein.

1. A fork movement assembly for a lift truck having a mast and a pair of forks, each of said forks having a hook portion located on a shank portion thereof, said assembly comprising:
a) a carriage comprising a pair of horizontally spaced apart vertical members and a frame support member secured transversely to said vertical members, said vertical members being adapted to be movably secured within said mast;
b) a side shift frame comprising an upper cross member, a spaced apart lower cross member, and two side members connecting said upper cross member to said lower cross member, said upper cross member being slidably connected to said frame support member, said upper cross member being adapted to support said pair of forks at said hook portion, said upper cross member defining a front face, said lower cross member defining a sliding surface, said sliding surface being adapted to permit fork positioning wherein said shank portion of said forks is located no further forward than said front face of said upper cross member; and
c) a side shift operator means for causing movement of said side shift frame along said frame support member, said side shift operator means being located in a portion of said frame support member.

2. The assembly of claim 1, further comprising:
a) a first fork shoe and a second fork shoe adapted to slide along said sliding surface, each of said fork shoes being adapted to engage one of said pair of forks, each of said fork shoes defining a fork contact surface adapted to receive said shank portion, said fork contact surface being located no further forward than a front face of said upper cross member, and
b) a fork positioner adapted to move said first fork shoe relative to said second fork shoe, said fork positioner being operatively connected to said fork shoes.

3. The assembly of claim 2, wherein the frame has a rectangular shape.

4. The assembly of claim 2, wherein each of said fork shoes defines a bottom edge, wherein at least a potion of said bottom edge of each of said fork shoes engages said sliding surface.

5. The assembly of claim 2, wherein said frame support member defines a convex upper contact surface and said upper cross member defines a lower concave contact surface, said convex upper contact surface being slidably received within a lower concave contact surface.

6. The assembly of claim 5, wherein said upper cross member defines a planar portion overhanging a front side of said frame support member.

7. The assembly of claim 2, wherein said side shift frame defines a planar front face, wherein said fork contact surface of said fork shoes is coplanar with said planar front face of said fame.

8. The assembly of claim 2, wherein the side shift operator means comprises a first piston and second piston, each of said pistons abutting against said side shift frame, said frame support member defining a first cavity and a second cavity, said first piston being slidably received in said first cavity and said second piston being slidably received in said second cavity, said first and second cavities being in fluid communication with a supply of hydraulic fluid, said first piston being adapted to slide said frame in one direction upon receiving an inflow of hydraulic fluid in said first cavity, and said second piston being adapted to slide the frame in an opposite direction upon receiving an inflow of hydraulic fluid in said second cavity.

9. The assembly of claim 8, wherein each of said pistons is sealed against each of said cavities by a gland nut.

10. The assembly of claim 8, further comprising first and second contact pads secured to said side shift frame, wherein said first piston abuts against said first contact pad and said second piston abuts against said second contact pad.

11. The assembly of claim 8, wherein the fork positioner comprises:
a) a hydraulic cylinder connected to said side shift frame, said hydraulic cylinder defining first and second cylinder ports communicating with a supply of hydraulic fluid; and
b) a rod received in said hydraulic cylinder, said rod being adapted for reciprocating movement in said hydraulic cylinder, said rod having a free end secured to said first fork shoe, said rod being adapted to move said first fork shoe away from said hydraulic cylinder upon hydraulic fluid entering said first cylinder port, and move said first fork shoe toward said hydraulic cylinder upon hydraulic fluid entering said second cylinder port; and
c) a centering assembly adapted to move said second fork shoe upon movement of said first fork shoe, wherein said first and second fork shoes are maintained at an equal distance from the center of said side shift frame.

12. The assembly of claim 11, wherein said centering assembly comprises a chain loop movably connected to said frame, said first and second fork shoes being secured to said chain loop, wherein movement of said first fork shoe actuated by said rod moves said chain loop, thereby moving said second fork shoe equidistantly.

13. The assembly of claim 12, wherein said chain loop comprises an upper chain connected to a lower chain.

14. A side shift assembly for a lift truck having a mast and a pair of forks, said assembly comprising:
a) a carriage comprising a pair of horizontally spaced apart vertical members and a frame support member secured transversely to said vertical members, said vertical members being adapted to be movably secured within said mast, said frame support member defining a front face and an upper contact surface
b) a side shift frame, said side shift frame comprising an upper cross member adapted to support said forks, said upper cross member defining:
i) a planar front portion covering said front face of said frame support member, and
ii) a lower contact surface adapted to engage said upper contact surface of said frame support member for sliding movement thereon; and
c) a side shift operator means for movement of said side shift frame along said frame support member, said shift means being located in a portion of said frame support member.

15. The assembly of claim 14, wherein said upper contact surface has a convex shape and said lower contact surface has a concave shape, said upper contact surface being slidably received in said lower contact surface.

16. The assembly of claim 15, wherein said side shift frame further comprises a lower cross member spaced apart from said upper cross member, said upper and lower cross members being substantially parallel, said upper and lower cross members being connected by spaced apart first and second side members to form a quadrilateral shape.

17. The assembly of claim 16, wherein said side shift frame has a rectangular shape.

18. The assembly of claim 16, wherein the shift means comprises a first piston and second piston, each of said pistons abutting against said side shift frame, said first piston being slidably received in a first cavity defined in said frame support member, said second piston being slidably received in a second cavity defined in said frame support member, said first and second cavities being in fluid communication with a supply of hydraulic fluid, said first piston being adapted to slide said frame in one direction upon receiving an inflow of hydraulic fluid in said first cavity, and said second piston being adapted to slide the side shift frame in an opposite direction upon receiving an inflow of hydraulic fluid in said second cavity.

19. The assembly of claim 18, wherein each of said pistons is sealed against each of said cavities by a gland nut.

20. The assembly of claim 18, further comprising first and second contact pads secured to said upper cross member, wherein said first piston abuts against said first contact pad and said second piston abuts against said second contact pad.

21. A fork movement assembly for a lift truck having a mast and a pair of forks, each of said pair of forks having a hook portion located on a shank portion thereof, said assembly comprising:
a) a carriage comprising a pair of horizontally spaced apart vertical members and a frame support member secured transversely to said vertical members, said vertical members being adapted to be movably secured within said mast;
b) a side shift frame comprising an upper cross member, said upper cross member being slidably connected to said frame support member, said upper cross member being adapted to support said forks along said hook portion;
c) a shift means for movement of said side shift frame along said frame support member, said shift means being located in a portion of said frame support member;
d) a first fork shoe and a second fork shoe movably secured to said side shift frame, each of said fork shoes defining a fork contact surface adapted to engage said shank portion, said fork contact surface being located no further forward than a front face of said upper cross member; and
e) a fork positioning means for moving said first fork shoe relative to said second fork shoe, wherein said first and second fork shoes are maintained at an equal distance from the center of said side shift frame, said fork positioning means being operatively connected to said fork shoes.
